(19) United States
(12) Patent Application Publication
(10) Pub. No.: US 2018/0106249 A1
(43) Pub. Date: Apr. 19, 2018

(54) CONTROL SYSTEM FOR SUPPLYING FUEL TO ENGINE

(71) Applicant: Caterpillar Inc., Peoria, IL (US)

(72) Inventors: Martin A. Lehman, Congerville, IL (US); Scott F. Shafer, Morton, IL (US); Daniel R. Puckett, Peoria, IL (US)

(73) Assignee: Caterpillar Inc., Peoria, IL (US)

(21) Appl. No.: 15/296,215

(22) Filed: Oct. 18, 2016

(51) Int. Cl. F04B 49/20; F02M 37/22; F02M 37/04; F04B 23/02; F04B 49/22; F04B 49/06; F02M 37/00

(52) U.S. Cl. CPC F04B 49/20; F02M 37/22; F02M 37/04; F02M 37/0052; F04B 49/22; F04B 49/065; F04B 23/02

(57) ABSTRACT

A control system for a fuel supply module of an engine is provided. The control system includes a first fuel flow sensor in a fuel supply line which detects a first amount of fuel flowing through the fuel supply line and generates a first signal indicative of the first amount of fuel. The control system includes a second fuel flow sensor in the fuel return line which detects a second amount of fuel flowing through the fuel return line and generates a second signal indicative of the second amount of fuel. A controller receives the first signal and the second signal. The controller calculates a difference between the first signal and the second signal. The controller commands operation of the fuel supply module to supply a fuel flow to the engine independent of the engine speed, based on the difference between the first signal and the second signal.

### TECHNICAL FIELD

The present disclosure relates to a fuel supply module for an engine. More specifically, the present disclosure relates to a control system for the fuel supply module of the engine.

### BACKGROUND

Reciprocating internal combustion (IC) engines are known for converting chemical energy stored in a fuel supply into mechanical shaft power. A fuel-oxidizer mixture is received in a variable volume of an IC engine defined by a piston translating within a cylinder bore. The fuel-oxidizer mixture burns inside the variable volume to convert chemical energy from the fuel-oxidizer mixture into heat. In turn, expansion of the combustion products within the variable volume performs work on the piston, which may be transferred to an output shaft of the IC engine.

Fuel supply systems for the combustion engines may inject high pressure liquid fuel directly into the variable volume, or the fuel supply system may employ two or more fuel pumping stages in series to achieve the desired final injection pressure. For example, common rail fuel systems for direct injection compression ignition engines may include a fuel transfer pump that draws fuel from a fuel tank and delivers the fuel to the inlet of a high pressure common rail pump, which further increases the fuel pressure to the desired injection pressure. Alternatively, other such configurations are also in use.

Controlling operation of the fuel pumps is a vital parameter for efficient operation of the fuel supply system. Generally, the fuel pumps are controlled based on various factors including machine configuration, operating conditions such as fuel pressure, fuel temperature etc. However, the present fuel supply control systems cater to a specific machine or a specific control system as the present control systems utilize system related parameters for controlling the fuel supply to the IC engine.

For example, JPH0829647 (hereinafter referred to as '647 reference) attains fuel atomization and vaporization at the time of the cold start of an engine by measuring a return fuel flow rate while the engine is in a cold condition. If the return fuel flow rate is outside a minimum flow rate range, fuel delivery quantity of a fuel pump is corrected. However, the '647 reference only applies the control logic while starting the engine and further utilizes other operating conditions such as cooling water temperature and oxygen content in exhaust gases to control the fuel pump.

Therefore, an improved control system for a fuel supply system is required to overcome the aforementioned problems.

### SUMMARY

In an aspect of the present disclosure, a control system for a fuel supply module of an engine is provided. The engine includes a fuel supply line permitting fuel to flow to the engine and a fuel return line permitting fuel to flow away from the engine to a reservoir. The control system includes a first fuel flow sensor located in the fuel supply line. The first fuel flow sensor detects a first amount of fuel flowing through the fuel supply line and generates a first signal indicative of the first amount of fuel flowing through the fuel supply line. The control system includes a second fuel flow sensor located in the fuel return line. The second fuel flow sensor detects a second amount of fuel flowing through the fuel return line and generates a second signal indicative of the second amount of fuel flowing through the fuel return line. The control system further includes a controller in communication with the fuel supply module, the first fuel flow sensor and the second fuel flow sensor. The controller receives the first signal indicative of the first amount of fuel flowing through the fuel supply line. The controller receives the second signal indicative of the second amount of fuel flowing through the fuel return line. The controller calculates a difference between the first signal and the second signal. Further, the controller commands operation of the fuel supply module to supply a fuel flow to the engine independent of the engine speed based on the difference between the first signal and the second signal.

In another aspect of the present disclosure, a method of supplying fuel to an engine is provided. The engine has a fuel supply line and a fuel return line. The method includes detecting a first amount of fuel flowing through the fuel supply line by a first fuel flow sensor, and generating a first signal indicative of the first amount of fuel flowing through the fuel supply line. The method includes detecting a second amount of fuel flowing through the fuel return line by a second fuel flow sensor, and generating a second signal indicative of the second amount of fuel flowing through the fuel return line. The method includes calculating a difference between the first signal and the second signal. The method further includes commanding operation of a fuel supply module by a controller, based on the difference between the first signal and the second signal.

In yet another aspect of the present disclosure, a fuel supply module for an engine is provided. The engine has a fuel supply line and a fuel return line. The fuel supply line allows fuel flow from a fuel reservoir to the engine and the fuel return line allows fuel flow from the engine to the fuel reservoir. The fuel supply module includes a motor. The fuel supply module includes a first pump mechanically coupled to the motor. The first pump has a first pump inlet and a first pump outlet. The fuel supply module includes a second pump mechanically coupled to the motor. The second pump has a second pump inlet and a second pump outlet. The fuel supply module includes a first filter assembly having a first filter inlet in fluid communication with the first pump outlet and a first filter outlet in fluid communication with both the first pump inlet and the second pump inlet. The fuel supply module includes a first fuel flow sensor located in the fuel supply line. The first fuel flow sensor detects a first amount of fuel flowing through the fuel supply line and generates a first signal indicative of the first amount of fuel flowing through the fuel supply line. The fuel supply module includes a second fuel flow sensor located in the fuel return line. The second fuel flow sensor detects a second amount of fuel flowing through the fuel return line and generates a second signal indicative of the second amount of fuel flowing through the fuel return line. The fuel supply module further includes a controller in communication with the fuel supply module, the first fuel flow sensor and the second fuel flow sensor. The controller receives the first signal and the second signal and calculates a difference between the first signal and the second signal. The controller commands operation of the fuel supply module to provide a fuel flow to the engine independent of engine speed, based on the difference between the first signal and the second signal.

### BRIEF DESCRIPTION OF DRAWINGS

FIG. 1 shows a side view of a machine, according to an aspect of the present disclosure;

FIG. 2 shows a schematic view of a fuel supply module, according to an aspect of the present disclosure; and

FIG. 3 shows a flowchart of a method of supplying fuel to an engine, according to an aspect of the present disclosure.

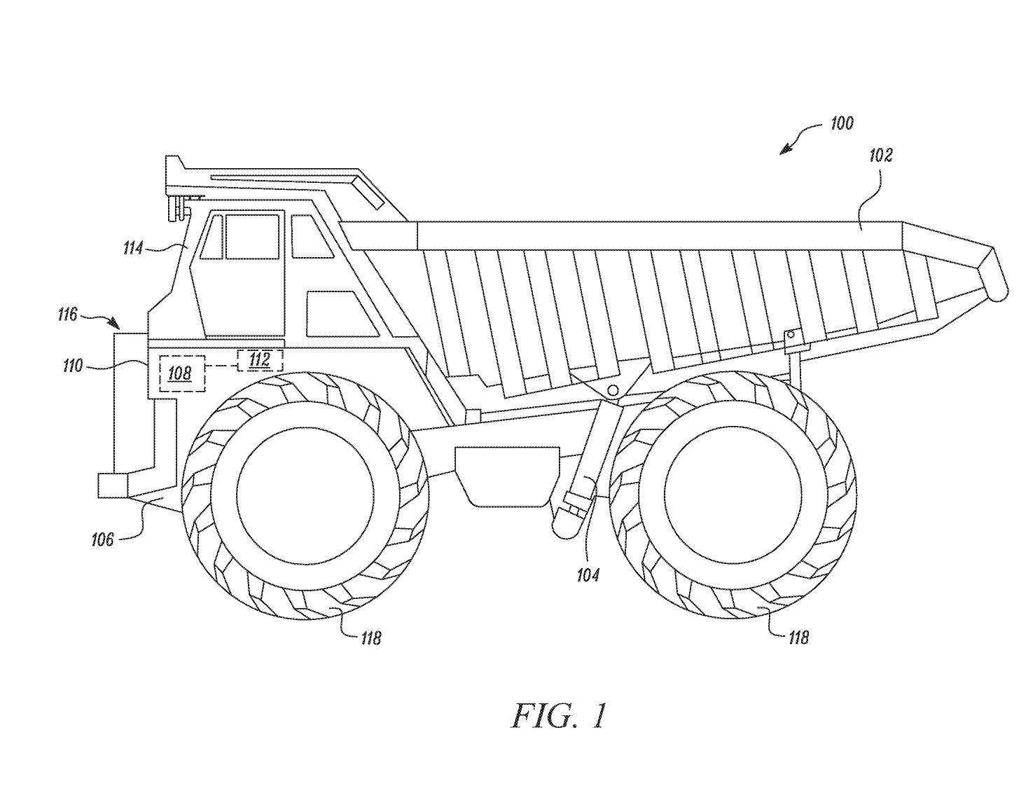

### DETAILED DESCRIPTION

Wherever possible, the same reference numbers will be used throughout the drawings to refer to same or like parts. FIG. 1 shows a side view of a machine 100, according to an aspect of the present disclosure. The machine 100 can be an “over-the-road” vehicle such as a truck used in transportation or may be any other type of machine which performs an operation associated with an industry such as mining, construction, farming, transportation etc. For example, the machine 100 may be an off-highway truck; an earth-moving machine, such as a wheel loader, an excavator, a dump truck, a backhoe, a motor grader, or a material handler; a marine vehicle or machine; a locomotive; or any other machine known in the art. The term “machine” may also refer to stationary equipment, such as a generator driven by an internal combustion engine to generate electricity. The machine 100 is illustrated as a dump truck having a dump bed 102 actuated by an actuation mechanism 104. In an exemplary aspect of the present disclosure, the actuation mechanism 104 may be hydraulically, or electrically and/or electro-mechanically operated.

The machine 100 includes a frame 106 and an engine 108 positioned in an engine compartment 110 supported on the frame 106. The engine 108 may be an internal combustion engine, for example, a petrol engine, a diesel engine, or a gas powered engine. The engine 108 is fluidly coupled to a fuel supply module 112. The fuel supply module 112 supplies fuel to the engine 108 for producing energy required to drive various parts and subsystems of the machine 100. In the illustrated embodiment, an operator cab 114 is mounted on a front end 116 of the frame 106 of the machine 100. The operator cab 114 may be located above the engine compartment 110 and may extend rearward beyond the engine 108. In some embodiments, the operator cab 114 may enclose the engine 108 by forming a portion of the engine compartment 110. In other embodiments, the operator cab 114 may be pivotally mounted to the frame 106, such that the operator cab 114 may be tilted to provide access to the engine 108. The machine 100 further includes a user interface (not shown) including user input devices for asserting control over the machine 100. The user interface may include pedals, wheels, joysticks, buttons, touch screens, combinations thereof, or any other user input devices known in the art. Alternatively or additionally, the user interface may include provisions for receiving control inputs remotely from the operator cab 114, including wired or wireless telemetry, for example.

The machine 100 may be propelled over a work surface by a pair of ground engaging elements 118 coupled to the frame 106. The ground engaging elements 118 may be driven by motors (not shown), a mechanical transmission (not shown) coupled to the engine 108, or combinations thereof. Although, the ground engaging elements 118 are illustrated as wheels, it should be understood that the machine 100 may also be propelled by a track assembly, a combination of wheels and a track assembly, or any other surface propulsion device known in the art. Alternatively, the machine 100 could be a stationary machine, and therefore may not include a propulsion device.

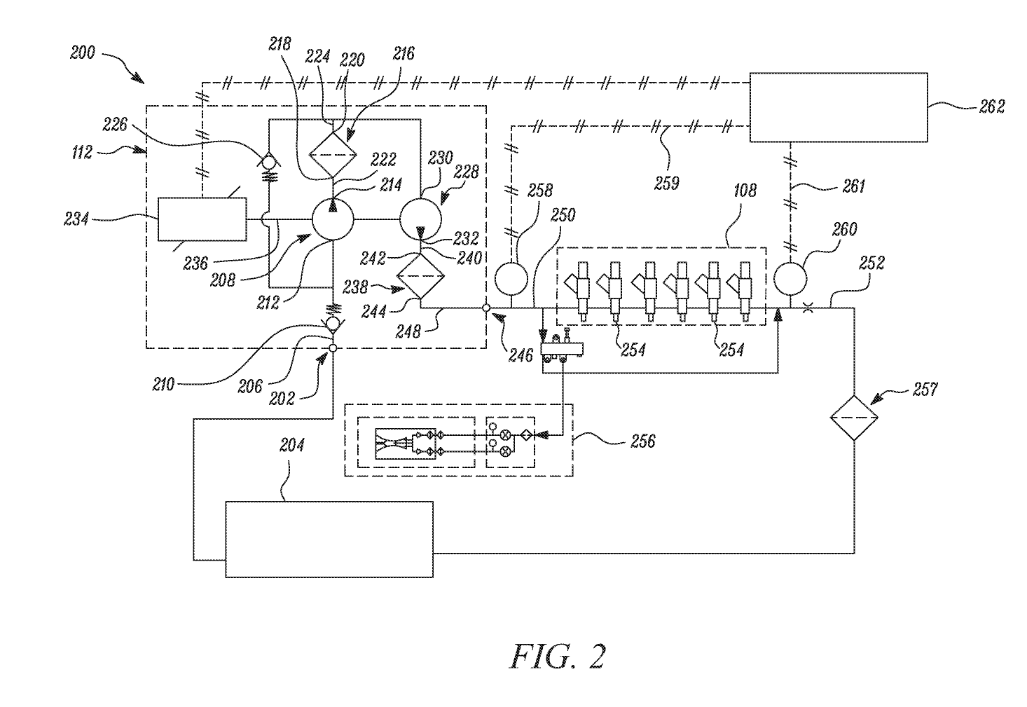

FIG. 2 schematically illustrates a control system 200 for the fuel supply module 112 of the engine 108. The fuel supply module 112 has a module inlet 202 fluidly coupled with a reservoir 204 through a module inlet conduit 206. The reservoir 204 supplies fuel to the module inlet 202 of the fuel supply module 112. Fuel flows from the module inlet 202 through the module inlet conduit 206 to a first pump 208. A first check valve 210 is provided in the module inlet conduit 206 to regulate fuel flow from the module inlet 202 to the first pump 208. The first check valve 210 ensures unidirectional flow of fuel from the module inlet 202 to the first pump 208. The first pump 208 has a first pump inlet 212 and a first pump outlet 214. The first pump 208 receives fuel from the first pump inlet 212 and pressurizes fuel to a first pressure as per the need of the present disclosure. The first pump 208 supplies fuel through the first pump outlet 214 to a first filter assembly 216.

The first filter assembly 216 has a first filter inlet 218 and a first filter outlet 220. The first filter inlet 218 is in fluid communication with the first pump outlet 214 through a first filter inlet conduit 222. Fuel supplied by the first pump 208 through the first pump outlet 214 flows to the first filter inlet 218 through the first filter inlet conduit 222. The first filter assembly 216 filters the fuel and separates any debris or other impurities which may be present in the fuel supplied by the first pump 208 which may hamper the operation of the engine 108. The first filter assembly 216 supplies fuel through the first filter outlet 220 to a first filter outlet conduit 224. The first filter outlet conduit 224 is fluidly coupled to the first pump inlet 212. A second check valve 226 is provided in the first filter outlet conduit 224 to regulate fuel flow through the first filter outlet 220 to the first pump inlet 212. The second check valve 226 ensures unidirectional flow of fuel from the first filter outlet 220 to the first pump inlet 212 through the first filter outlet conduit 224. A first portion of fuel passing from the first filter outlet 220 is recirculated back to the first pump inlet 212 via the first check valve 210. As the first portion of fuel is passed through the first filter assembly 216 multiple times, effectiveness of filtration increases and operational efficiency of the engine 108 is improved as well due to improved quality of fuel being supplied to the engine 108. Further, the first filter outlet conduit 224 is also in fluid communication with a second pump 228 which receives a second portion of fuel flowing out of the first filter outlet 220.

The second pump 228 has a second pump inlet 230 and a second pump outlet 232. The second pump 228 receives fuel from the first filter outlet conduit 224 through the second pump inlet 230 and pressurizes fuel to a second pressure as per the need of the present disclosure. The second pressure may be greater than the first pressure. A motor 234 drives the first pump 208 and the second pump 228. The motor 234 may be driven electrically or hydraulically or may derive a portion of power from the power produced by the engine 108. The motor 234 supplies power to the first pump 208 and the second pump 228 through a shaft 236. Although only one shaft 236 is shown, it should be contemplated that two separate shafts may also be provided for controlling the first pump 208 and the second pump 228 independently. In an exemplary embodiment, the control system 200 may include a second motor (not shown) for running the second pump 228. The second motor may be connected to the second pump 228 through a shaft (not shown) similar to the shaft 236.

Fuel flows through the second pump outlet 232 to a second filter assembly 238 through a second filter inlet conduit 240. The second filter assembly 238 includes a second filter inlet 242 and a second filter outlet 244. The second filter inlet 242 is in fluid communication with the second filter inlet conduit 240 and the second filter assembly 238 receives fuel through the second filter inlet 242. The second filter assembly 238 filters the fuel and separates any debris or other impurities which may be present in fuel after the fuel passes through the first filter assembly 216. The second filter assembly 238 supplies fuel from the second filter outlet 244 to a module outlet 246 through a second filter outlet conduit 248. Fuel flows through the module outlet 246 to the engine 108.

The engine 108 includes a fuel supply line 250 and a fuel return line 252. The fuel supply line 250 is adapted to permit a flow of fuel to the engine 108 and the fuel return line 252 is adapted to permit a flow of fuel away from the engine 108. The fuel supply line 250 is fluidly coupled to the module outlet 246. Fuel flowing through the fuel supply line 250 to the engine 108 is used for injecting fuel into multiple combustion cylinders 254 for producing energy, for cooling requirements of the engine 108 and for recirculating through the regeneration system 256. The regeneration system 256 may include various components such as a Diesel Oxidation Catalyst (DOC) (not shown), a Particulate Filter (PF) (not shown) and various other components such as, but not limited to, a selective catalytic reduction (SCR) catalyst, a three-way catalyst, a NOx trap, and/or various other emission control devices or combinations thereof. Exhaust gases produced by the engine 108 are passed through the regeneration system 256 and a small quantity of fuel is sprayed over the exhaust gases to convert harmful gaseous substances such as Nitrogen Oxides (NOx) in to simpler substances such as Carbon Dioxide (CO2) and water vapors. Residual fuel is carried away from the engine 108 by the fuel return line 252 to the reservoir 204. The fuel return line 252 may include means to cool the residual fuel before supplying the fuel to the reservoir 204. The fuel return line 252 is provided with a filter 257 as well for filtering the residual fuel. It should be contemplated that the cooling means for residual fuel as well as the filter 257 may or may not be present in the control system 200. Only the cooling means or only the filter 257 may be present as well. Various other such subsystems may also be present in the control system 200 which are not discussed here. The present disclosure is not limited to any such description in any manner.

The control system 200 includes a first fuel flow sensor 258 located in the fuel supply line 250. The first fuel flow sensor 258 measures a first amount of fuel flowing through the fuel supply line 250. The first fuel flow sensor 258 may be any type of a conventional flow sensor known in the art which may be suitable to the present application. The first fuel flow sensor 258 generates a first signal 259 corresponding to the first amount of fuel flowing in the fuel supply line 250. The control system 200 includes a second fuel flow sensor 260 located in the fuel return line 252. The second fuel flow sensor 260 measures a second amount of fuel flowing through the fuel return line 252. The second fuel flow sensor 260 may be any type of a conventional flow sensor known in the art which may be suitable to the present application. The second fuel flow sensor 260 generates a second signal 261 corresponding to the first amount of fuel flowing in the fuel return line 252. The control system 200 further includes a controller 262.

The controller 262 may be a single controller or multiple controllers working together to perform a variety of tasks. The controller 262 may embody a single or multiple microprocessors, field programmable gate arrays (FPGAs), digital signal processors (DSPs), etc., that include a means for controlling operations of the fuel supply module 112 in response to operator requests, built-in constraints, sensed operational parameters, and/or communicated instructions from an off-board controller (not shown). Numerous commercially available microprocessors can be configured to perform the functions of the controller 262. Various known circuits may be associated with the controller 262, including power supply circuitry, signal-conditioning circuitry, actuator driver circuitry (i.e., circuitry powering solenoids, motors, or piezo actuators), and communication circuitry. The controller 262 may also be an Engine Control Unit (ECU) of the machine 100.

The controller 262 receives the first signal 259 generated by the first fuel flow sensor 258 and the second signal 261 generated by the second fuel flow sensor 260. The controller 262 may process the first signal 259 and the second signal 261 to determine values of the first amount of fuel flowing through the fuel supply line 250 and the second amount of fuel flowing through the fuel return line 252. The controller 262 calculates a difference between the first signal 259 and the second signal 261. The difference between the first signal 259 and the second signal 261 indicates an amount of fuel being used by the engine 108. Further, the controller 262 commands operation of the fuel supply module 112 to supply fuel to the engine 108 based on the difference between the first signal 259 and the second signal 261.

The controller 262 controls the operation of the fuel supply module 112 independent of an engine speed. The controller 262 takes into account only the difference between the first signal 259 and the second signal 261. In an embodiment, the controller 262 may have a desired or ideal value of the difference between the first signal 259 and the second signal 261 stored in an associated memory of the controller 262. The controller 262 may compare the calculated value of the difference between the first signal 259 and the second signal 261 with the stored value and command the operation of the fuel supply module 112 accordingly. Further, the controller 262 may control a speed of the motor 234 of the fuel supply module 112 to control the operation of the fuel supply module 112. As the first pump 208 and the second pump 228 are mechanically coupled with the motor 234 through the shaft 236, the controller 262 subsequently controls the operation of the first pump 208 and second pump 228 as well by controlling the speed of the motor 234. In one embodiment, the controller 262 may also be coupled to the second motor which may control the operation of the second pump 228. The controller 262 may control the operation of the second pump 228 by controlling a speed of the second motor accordingly.

### INDUSTRIAL APPLICABILITY

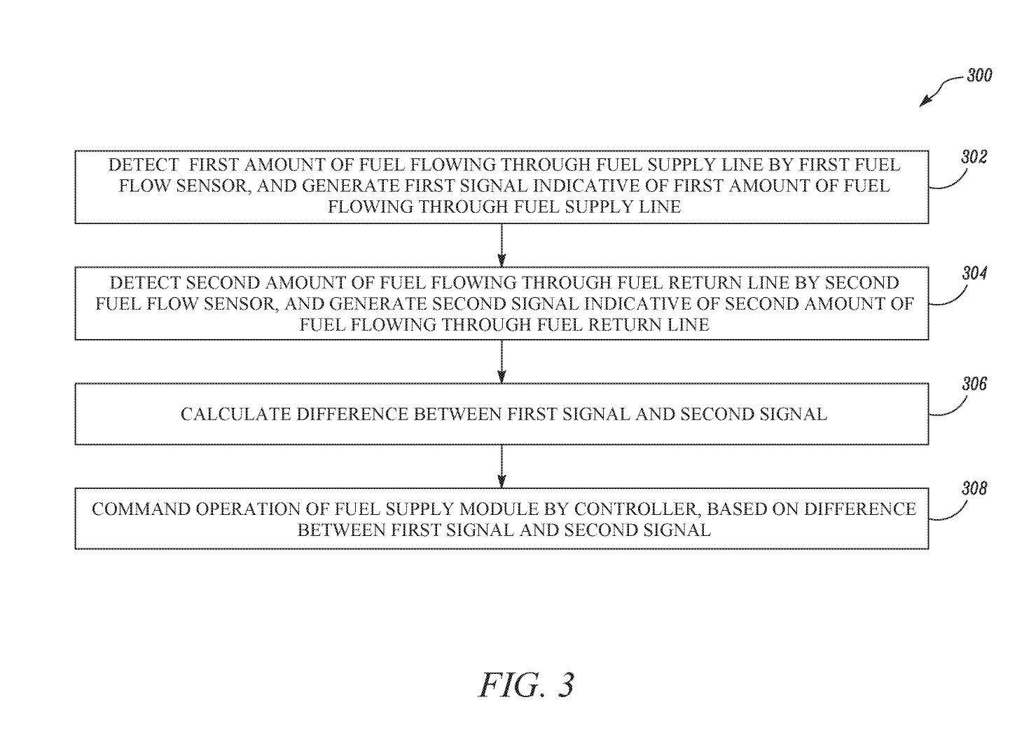

The present disclosure provides a method 300 of supplying fuel to the engine 108 as shown in FIG. 3. The engine 108 has the fuel supply line 250 and the fuel return line 252. The method 300 at step 302 detects the first amount of fuel flowing through the fuel supply line 250 by the first fuel flow sensor 258. The first fuel flow sensor 258 generates the first signal 259 indicative of the first amount of fuel flowing through the fuel supply line 250. The method 300 at step 304 detects the second amount of fuel flowing through the fuel return line 252 by the second fuel flow sensor 260. The second fuel flow sensor 260 generates the second signal 261 indicative of the second amount of fuel flowing through the fuel return line 252. The method 300 at step 306 calculates a difference between the first signal 259 and the second signal 261. The difference between the first signal 259 and the second signal 261 is indicative of the amount of fuel consumed by the engine 108.

The method 300 at step 308 commands operation of the fuel supply module 112 by the controller 262. The controller 262 controls the operation of the fuel supply module 112 based on the difference between the first signal 259 and the second signal 261. In one embodiment, the controller 262 may have a value of the difference between the first signal 259 and the second signal 261 stored in the associated memory. The controller 262 may compare the calculated value of the difference between the first signal 259 and the second signal 261 with the stored value and control the operation of the fuel supply module 112 based on the comparison. In another embodiment, the controller 262 may control the fuel supply module 112 by controlling the speed of the motor 234 of the fuel supply module 112. As the first pump 208 and the second pump 228 are mechanically coupled to the motor 234 through the shaft 236, the controller 262 controls the operation of the first pump 208 and the second pump 228 as well by controlling the motor 234.

The method 300 utilizes the first signal 259 and the second signal 261 to control the operation of the fuel supply module 112. The first signal 259 and the second signal 261 are generated by the first fuel flow sensor 258 and the second fuel flow sensor 260 respectively. The first fuel flow sensor 258 and the second fuel flow sensor 260 directly provide values of the amount of fuel flowing through the fuel supply line 250 and the fuel return line 252. The method 300 does not depend upon machine configurations, engine speed and other factors to determine the amount of fuel being used by the engine 108. More appropriate and accurate calculations are performed using the method 300 and real time fuel consumption by the engine 108 may be determined for using in various purposes such as, but not limited to, diagnostics, periodic maintenance and service procedures etc. This simplifies control logic to a great extent and increases overall control efficiency of the control system 200, which in turn, enhances fuel efficiency of the engine 108.

Further, the controller 262 may also determine health of various components of the fuel supply module 112 by measuring the fuel flow and electrical current required to generate the desired fuel flow. Status of wear of the first pump 208 and the second pump 228, and loading status of the first filter assembly 216 and the second filter assembly 238 may be determined by utilizing the data collected by the method 300 as well as various other system configuration data pre-stored in the associated memory of the controller 262.

The control system 200 may also determine an amount of fuel being used by the regeneration system. The controller 262 may determine the amount of fuel being used by the regeneration system, or any other such emission control devices. Generally, the regeneration system does not run continuously, rather the regeneration system is only operational when required. Therefore, the amount of fuel consumed by the regeneration system may be used to estimate status of health of the regeneration system or any other emission control devices. The amount of fuel consumed by the regeneration system can be a potential indicator of effectiveness of the regeneration system and necessary control steps may be taken accordingly for maintenance of the regeneration system. The control system 200 may be easily retrofitted across various products as the control system 200 is designed in a way such that the control system 200 can be used by various generations and models of different machines.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A control system for a fuel supply module of an engine, the engine having a fuel supply line permitting fuel to flow to the engine and a fuel return line permitting fuel to flow away from the engine to a reservoir, the control system comprising:
a first fuel flow sensor disposed in the fuel supply line, the first fuel flow sensor configured to detect a first amount of fuel flowing through the fuel supply line and generate a first signal indicative of the first amount of fuel flowing through the fuel supply line;
a second fuel flow sensor disposed in the fuel return line, the second fuel flow sensor configured to detect a second amount of fuel flowing through the fuel return line and generate a second signal indicative of the second amount of fuel flowing through the fuel return line;
a controller in communication with the fuel supply module, the first fuel flow sensor and the second fuel flow sensor, the controller configured to
receive the first signal indicative of the first amount of fuel flowing through the fuel supply line,
receive the second signal indicative of the second amount of fuel flowing through the fuel return line,
calculate a difference between the first signal and the second signal, and
command operation of the fuel supply module to supply a fuel flow to the engine independent of engine speed based on the difference between the first signal and the second signal.

2. The control system of claim 1, wherein the controller further compares the difference between the first signal and the second signal with a pre-stored value and commands the operation of the fuel supply module based on comparison of the difference between the first signal and the second signal.

3. The control system of claim 1, wherein the fuel supply module includes a motor, a first pump, a first filter, a second pump and a second filter.

4. The control system of claim 3, wherein the motor is mechanically coupled to the first pump and the second pump.

5. The control system of claim 3, wherein the controller commands the operation of the fuel supply module by controlling speed of the motor of the fuel supply module.

6. The control system of claim 3, wherein the first pump is fluidly coupled to the reservoir at an inlet of the first pump.

7. The control system of claim 5, wherein fuel flows from the reservoir to an inlet of the first pump through a check valve.

8. The control system of claim 3, wherein the second filter is fluidly coupled to the fuel supply line at an outlet of the second filter.

9. A method of supplying fuel to an engine, the engine having a fuel supply line and a fuel return line, the method comprising:
detecting by a first fuel flow sensor, a first amount of fuel flowing through the fuel supply line and generating a first signal indicative of the first amount of fuel flowing through the fuel supply line;
detecting by a second fuel flow sensor, a second amount of fuel flowing through the fuel return line and generating a second signal indicative of the second amount of fuel flowing through the fuel return line;
calculating a difference between the first signal and the second signal; and
commanding operation of a fuel supply module, by a controller, based on the difference between the first signal and the second signal.

10. The method of claim 9, wherein the controller further compares the difference between the first signal and the second signal with a pre-stored value and commands the operation of the fuel supply module based on comparison of the difference between the first signal and the second signal.

11. The method of claim 9, wherein the controller commands operation of the fuel supply module by controlling speed of a motor connected to a first pump of the fuel supply module.

12. The method of claim 11, wherein controller commands operation of the fuel supply module by controlling speed of the motor, which is connected to a second pump, wherein the first pump and the second pump are fluidly connected in series.

13. A fuel supply module for an engine, the engine having a fuel supply line and a fuel return line, the fuel supply line configured to allow fuel flow from a fuel reservoir to the engine and the fuel return line configured to allow fuel flow from the engine to the fuel reservoir, the fuel supply module comprising:
a motor;
a first pump mechanically coupled to the motor, the first pump having a first pump inlet and a first pump outlet;
a second pump mechanically coupled to the motor, the second pump having a second pump inlet and a second pump outlet;
a first filter assembly having a first filter inlet in fluid communication with the first pump outlet and a first filter outlet in fluid communication with both the first pump inlet and the second pump inlet;
a first fuel flow sensor disposed in the fuel supply line, the first fuel flow sensor configured to detect a first amount of fuel flowing through the fuel supply line and generate a first signal indicative of the first amount of fuel flowing through the fuel supply line;
a second fuel flow sensor disposed in the fuel return line, the second fuel flow sensor configured to detect a second amount of fuel flowing through the fuel return line and generate a second signal indicative of the second amount of fuel flowing through the fuel return line;
a controller in communication with the fuel supply module, the first fuel flow sensor and the second fuel flow sensor, the controller being configured to:
receive the first signal and the second signal,
calculate a difference between the first signal and the second signal,
command operation of the fuel supply module to provide the first amount of fuel to the engine, independent of engine speed, based on the difference between the first signal and the second signal.

14. The fuel supply module of claim 13, wherein the controller further compares the difference between the first signal and the second signal with a pre-stored value and commands the operation of the fuel supply module based on comparison of the difference between the first signal and the second signal.

15. The fuel supply module of claim 13, wherein the controller commands the operation of the fuel supply module by controlling speed of the motor of the fuel supply module.

16. The fuel supply module of claim 13, wherein the fuel supply module further includes a second filter assembly having a second filter inlet in fluid communication with the second pump outlet and a second filter outlet in fluid communication with the fuel supply line.
